(19) United States
(12) Patent Application Publication
(10) Pub. No.: US 2012/0096423 A1
(43) Pub. Date: Apr. 19, 2012

(54) METHOD FOR DESIGNING LED DRIVER CIRCUIT

(75) Inventor: Chih-Yang Chang, Pingzhen City (TW)

(73) Assignee: Rui Teng Opto Technology Co., Ltd., Pingzhen City (TW)

(21) Appl. No.: 13/289,526

(22) Filed: Nov. 4, 2011

Related U.S. Application Data
(63) Continuation-in-part of application No. 12/421,460, filed on Apr. 9, 2009.

(30) Foreign Application Priority Data
Sep. 12, 2008 (TW) 097216582

(51) Int. Cl. G06F 17/50

(52) U.S. Cl. 716/133

(57) ABSTRACT

A method for designing an LED driver circuit is disclosed, wherein the LED driver circuit serves to drive an LED circuit. The method includes the steps of: providing an LED driver circuit; calculating a design voltage and a design current; designing an actual driving voltage; designing a voltage output end voltage; and designing an actual driving current. The LED driver circuit includes a power source IC and a current-limiting resistor. The current-limiting resistor is electrically connected between a voltage output end and a voltage-regulating end of the power source IC. The actual driving current is designed by calculating the actual driving voltage and the voltage output end voltage according to the design voltage and by calculating the resistance value of the current-limiting resistor according to the design current. With the disclosed method, the design of an LED driver circuit capable of a stable and constant current can be rapidly completed.

### CROSS-REFERENCE TO RELATED APPLICATION

This application is a continuation-in-part (CIP) of U.S. patent application Ser. No. 12/421,460 filed on Apr. 9, 2009 and entitled “LED LIGHT SOURCE MODULE AND CONSTANT-CURRENT UNIT STRUCTURE FOR USE THEREWITH”. The disclosure of the related application is incorporated herein by reference.

### BACKGROUND OF THE INVENTION

1. Technical Field

The present invention relates to a method for designing a light-emitting diode (LED) driver circuit and, more particularly, to a method for designing an LED driver circuit configured for driving an LED circuit.

2. Description of Related Art

FIG. 1 is a circuit diagram of a conventional LED light source module 10. As shown in the FIG. 1, the conventional LED light source module 10 includes a plurality of light-emitting units 11 each connected to a direct-current (DC) voltage source 12 in parallel. Each of the light-emitting units 11 includes a resistor 111 and a plurality of LEDs 112, wherein the LEDs 112 and the resistor 111 are connected in series so that the LEDs 112 can be powered on by the DC voltage from the DC voltage source 12 and emit light.

Referring to FIG. 1, in case of stable voltage from the DC voltage source 12, the magnitude of current entering the LEDs 112 in each light-emitting unit 11 is constant under the control of the resistor 111 series-connected to the LEDs 112, so the LEDs 112 emit light steadily.

However, a slight fluctuation in the voltage from the DC voltage source 12 will result in significant variation in the current entering the light-emitting units 11. The unstable current not only has a destabilizing effect on the luminance of light emitted by the LEDs 112 in the light-emitting units 11, but also causes the LEDs 112 to generate heat unsteadily, which may in turn shorten the service lives of the LEDs 112.

To solve the aforesaid problems, LED driver circuits featuring constant current output were developed to protect the LEDs 112 from being substantially affected should the voltage from the DC voltage source 12 fluctuate slightly. Nevertheless, as the light-emitting units 11 of the LED light source module 10 can be connected in series, in parallel, or in series and parallel, an LED driver circuit for use with the LED light source module 10 must be designed according to the actual connection mode of the light-emitting units 11. Considering the various possible connection modes, the design process of such LED driver circuits is, without a doubt, time-consuming If an LED driver circuit capable of providing stable and constant current can be rapidly designed as needed, the cost of design will be greatly reduced.

### BRIEF SUMMARY OF THE INVENTION

The present invention relates to a method for designing an LED driver circuit, and the method includes the steps of: providing an LED driver circuit; calculating a design voltage and a design current; designing an actual driving voltage; designing a voltage output end voltage; and designing an actual driving current. The major objective of the present invention is to enable rapid design of an LED driver circuit capable of supplying stable and constant current.

The present invention provides a method for designing an LED driver circuit, wherein the LED driver circuit is configured for driving an LED circuit. The method begins by providing an LED driver circuit. The LED driver circuit includes a power source integrated circuit (IC) and a current-limiting resistor. The power source IC has a voltage output end and a voltage-regulating end, wherein the voltage-regulating end serves to provide the electric power required for driving the LED circuit. The current-limiting resistor is electrically connected between the voltage output end and the voltage-regulating end. Then, a design voltage and a design current are calculated, wherein the design voltage and the design current are required for driving the LED circuit. Afterward, an actual driving voltage is designed. More specifically, the design voltage is used as a voltage-regulating end voltage at the voltage-regulating end, and the voltage-regulating end voltage serves as the actual driving voltage for driving the LED circuit. Following that, a voltage output end voltage is obtained by adding a potential difference of +0.4V˜+3V to the voltage-regulating end voltage. Finally, an actual driving current is designed, in which step the design current and the potential difference are substituted into the Ohm's law equation to produce a resistance value, and the resistance of the current-limiting resistor is set at this resistance value, so as for the LED driver circuit to output the actual driving current for driving the LED circuit.

Implementation of the present invention at least involves the following inventive steps:

1. The design of an LED driver circuit can be rapidly completed, and the resultant LED driver circuit can provide a stable driving current.

2. The same driving current is supplied to each LED in the LED circuit driven by the LED driver circuit. Thus, the luminance of light emitted by all the LEDs in the LED circuit is rendered uniform.

The detailed features and advantages of the present invention will be described in detail with reference to the preferred embodiment so as to enable persons skilled in the art to gain insight into the technical disclosure of the present invention, implement the present invention accordingly, and readily understand the objectives and advantages of the present invention by perusal of the contents disclosed in the specification, the claims, and the accompanying drawings.

### BRIEF DESCRIPTION OF THE SEVERAL VIEWS OF THE DRAWINGS

FIG. 1 is a circuit diagram of a conventional LED light source module;

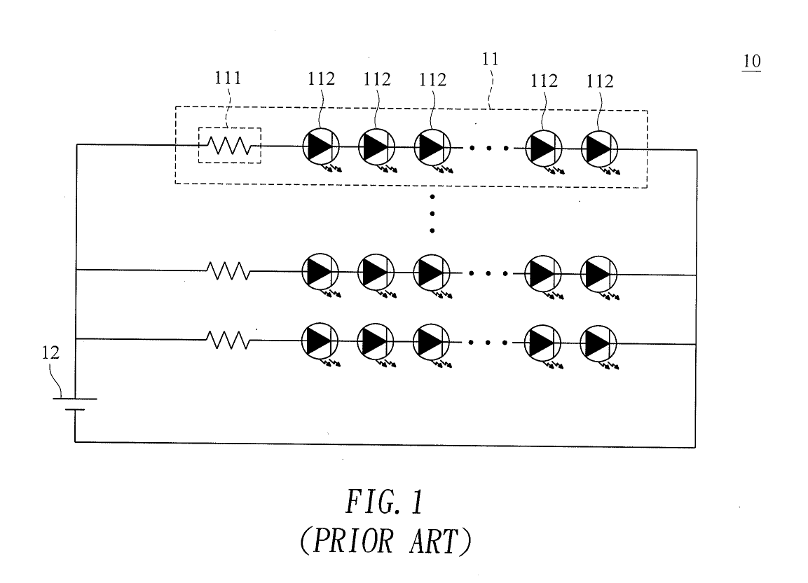

FIG. 2 is the flowchart of a method for designing an LED driver circuit according to an embodiment of the present invention;

FIG. 3 is a circuit diagram of an LED driver circuit according to an embodiment of the present invention;

FIG. 4 is a circuit diagram showing an LED circuit electrically connected with an LED driver circuit according to an embodiment of the present invention; and

FIG. 5 is an equivalent circuit diagram of FIG. 4, as a result of simplifying the circuit in FIG. 4.

### DETAILED DESCRIPTION OF THE INVENTION

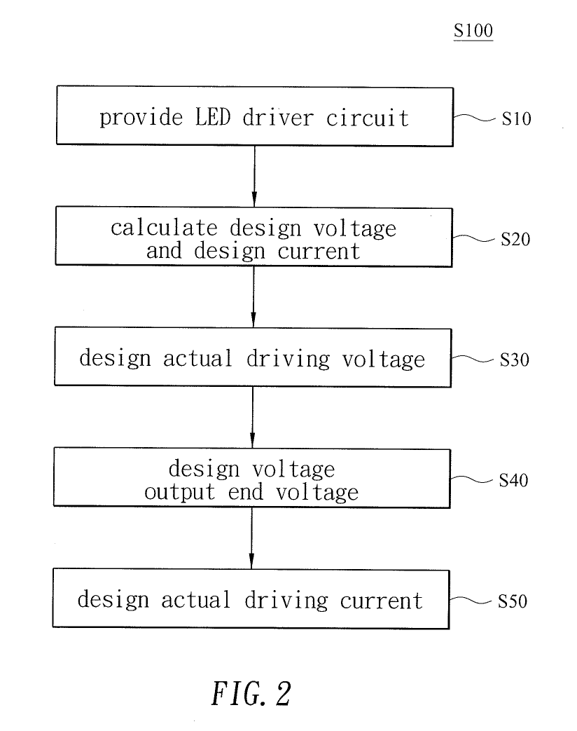

Referring to FIG. 2, a method for designing an LED driver circuit according to an embodiment of the present invention includes the steps of: providing an LED driver circuit (step S10); calculating a design voltage and a design current (step S20); calculating an actual driving voltage (step S30); designing a voltage output end voltage (step S40); and designing an actual driving current (step S50).

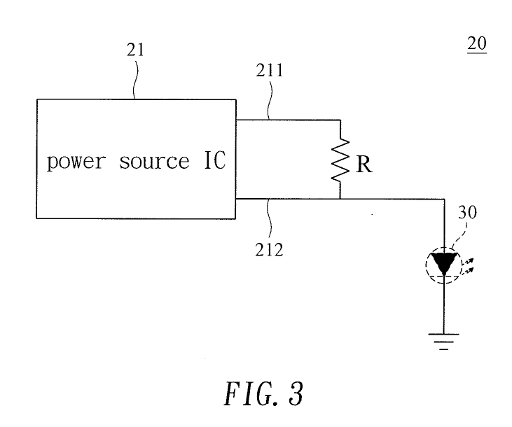

The step of providing an LED driver circuit (step S10) is described as follows. Referring to FIG. 3, the LED driver circuit 20, which is the circuit to be designed in this embodiment, includes a power source IC 21 and a current-limiting resistor R. The LED driver circuit 20 is used to drive an LED circuit 30.

The power source IC 21 can be a voltage-stabilizing IC. The power source IC 21 has such output ends as a voltage output end 211 and a voltage-regulating end 212. For example, the voltage output end 211 is a V_{DD} output end, and the voltage-regulating end 212 is a V_{SS} output end. The current-limiting resistor R is electrically connected between the voltage output end 211 and the voltage-regulating end 212 and contributes to the design of the actual driving current, as detailed further below.

The voltage output end 211 and the voltage-regulating end 212 are electrically connected by the current-limiting resistor R and are not grounded immediately after such a connection. The LED circuit 30, on the other hand, is electrically connected to the voltage-regulating end 212 and is driven by the electric power supplied therefrom. In other words, the voltage output end 211, the voltage-regulating end 212, and the LED circuit 30 are in a series-connected circuit where there is no current division. Therefore, the voltage-regulating end 212 can be so designed that it drives the LED circuit 30 by providing the same driving current to each LED in the LED circuit 30, thus allowing the LEDs to have uniform luminance.

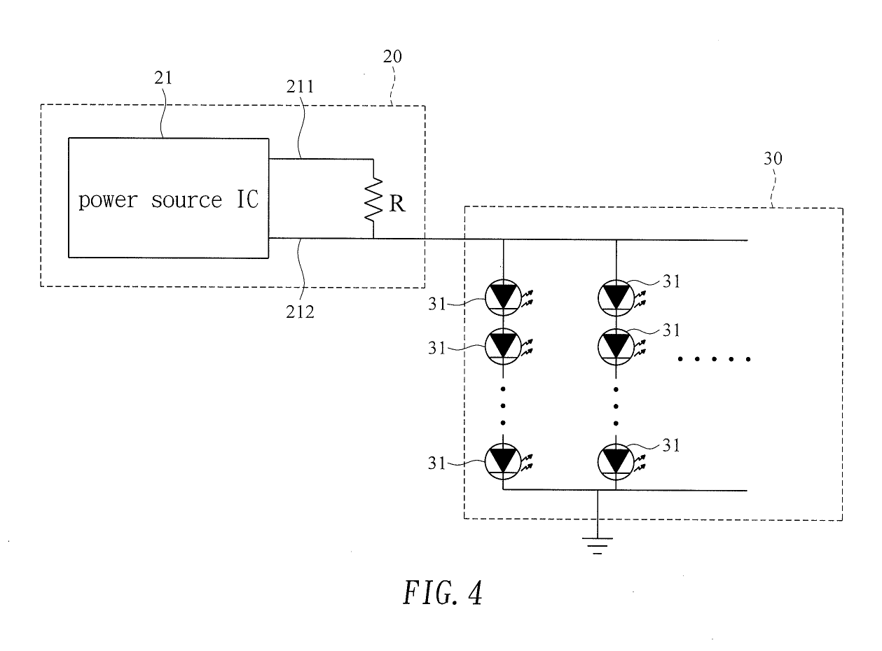

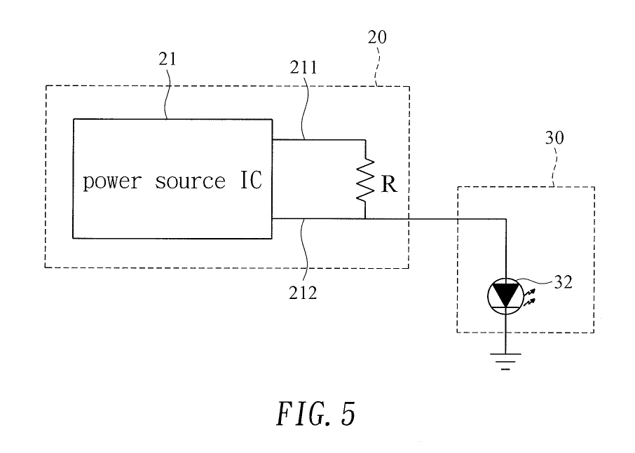

The step of calculating a design voltage and a design current (step S20) is now explained with reference to FIGS. 4 and 5. This step calculates the design voltage and design current required for driving the LED circuit 30. It should be pointed out in the first place that the LED circuit 30 includes a plurality of LEDs 31 that is connected in series, in parallel, or in series and parallel. Therefore, in order to simplify the design process, calculation of the design voltage and the design current begins by simplifying the plural LEDs 31—be they connected in series, in parallel, or in series and parallel—into a single-LED equivalent circuit 32. This can be done according to the critical voltage and the characteristic curve of the driving current of each LED 31, both of which information can be known from the specifications of the LEDs 31. Then, the design values of the design voltage and of the design current are calculated according to this single-LED equivalent circuit 32. More specifically, the design voltage can be designed according to the critical voltage of the single-LED equivalent circuit 32, and the design current can be equal to the driving current of the single-LED equivalent circuit 32.

In order to drive the LED circuit 30, the design voltage can be designed to be equal to the critical voltage of the LED circuit 30 or, more particularly, the critical voltage of the single-LED equivalent circuit 32 of the LED circuit 30. Nevertheless, a better approach is to add a positive voltage difference of +0.5V˜+5V to the critical voltage of the LED circuit 30 and use the sum as the design voltage. This ensures that the LED circuit 30 will be properly driven.

The step of designing an actual driving voltage (step S30) is carried out in the following manner. The design voltage is used as a voltage-regulating end voltage at the voltage-regulating end 212, and this voltage-regulating end voltage is the actual driving voltage. More particularly, since the LED circuit 30 must be driven by a sufficiently high driving voltage and a sufficiently large driving current, the design voltage obtained from the previous step is used as the voltage-regulating end voltage, and the voltage-regulating end voltage is taken as the actual driving voltage for driving the LED circuit 30 because the voltage-regulating end 212 and the input end of the LED circuit 30 coincide at the same node.

In the step of designing a voltage output end voltage (step S40), a potential difference ranging from +0.4V to +3V is added to the voltage-regulating end voltage to produce the voltage output end voltage. In order to supply a sufficiently large driving current to the LED circuit 30, the voltage output end voltage at the voltage output end 211 must be higher than the voltage-regulating end voltage by an adequate potential difference, and this is why the voltage-regulating end voltage is added with the potential difference of +0.4V˜+3V. An appropriate actual driving current can be obtained by using a suitable current-limiting resistor R in conjunction with a suitable design value of the potential difference (e.g., +0.4V, +0.5V, or +1.1V).

In the step of designing an actual driving current (step S50), the previously determined design current and the potential difference in the last step are substituted into the Ohm's law equation for calculation, and the resistance of the current-limiting resistor R is set at the resistance value thus obtained. Once the resistance of the current-limiting resistor R is determined, the LED driver circuit 20 can output a stable actual driving current for driving the LED circuit 30.

To sum up, the disclosed method starts by obtaining the critical voltage and the characteristic curve of the driving current of each LED 31 in the LED circuit 30 from the specifications of the LEDs 31. Next, the voltage and current required for driving the LED circuit 30 are calculated as the basis for calculating the design voltage and the design current. Afterward, the design voltage is used as the voltage-regulating end voltage at the voltage-regulating end 212 and consequently the actual driving voltage for driving the LED circuit 30. A specific potential difference is then added to the voltage-regulating end voltage to produce the voltage output end voltage.

Finally, the resistance value of the current-limiting resistor R is calculated by substituting the known design current and the known potential difference into the Ohm's law equation, and this can be done rapidly. Once the resistance of the current-limiting resistor R is set, the LED driver circuit 20 can output a steady actual driving current based on the voltage output end voltage, the voltage-regulating end voltage, and the resistance of the current-limiting resistor R. Thus, by precisely designing the resistance of the current-limiting resistor R and rapidly determining the voltage output end voltage and the voltage-regulating end voltage, the design process of the LED driver circuit 20 is accelerated. Not only that, the resultant LED driver circuit 20 is capable of providing a stable driving current.

The features of the present invention are disclosed above by the preferred embodiment to allow persons skilled in the art to gain insight into the contents of the present invention and implement the present invention accordingly. The preferred embodiment of the present invention should not be interpreted as restrictive of the scope of the present invention. Hence, all equivalent modifications or amendments made to the aforesaid embodiment should fall within the scope of the appended claims.

What is claimed is:

1. A method for designing a light-emitting diode (LED) driver circuit, wherein the LED driver circuit is configured for driving an LED circuit, the method comprising the steps of:
providing the LED driver circuit, the LED driver circuit comprising: a power source integrated circuit (IC) having a voltage output end and a voltage-regulating end; and a current-limiting resistor electrically connected between the voltage output end and the voltage-regulating end, wherein the voltage-regulating end serves to provide electric power for driving the LED circuit;
calculating a design voltage and a design current that are required for driving the LED circuit;
designing an actual driving voltage, wherein the design voltage is used as a voltage-regulating end voltage at the voltage-regulating end, and the voltage-regulating end voltage is the actual driving voltage for driving the LED circuit;
designing a voltage output end voltage by adding a potential difference ranging from +0.4V to +3V to the voltage-regulating end voltage; and
designing an actual driving current by substituting the design current and the potential difference into the Ohm's law equation to produce a resistance value, and setting the resistance value as the resistance of the current-limiting resistor, so as for the LED driver circuit to output the actual driving current for driving the LED circuit.

2. The method of claim 1, wherein the power source IC is a voltage-stabilizing IC.

3. The method of claim 2, wherein the voltage output end and the voltage-regulating end of the voltage-stabilizing IC are a V_{DD} output end and a V_{SS} output end respectively.

4. The method of claim 1, wherein the design voltage is equal to a critical voltage of the LED circuit.

5. The method of claim 4, wherein the design voltage is equal to the critical voltage added with a positive voltage difference.

6. The method of claim 1, wherein the potential difference is one of +0.4V. +0.5V, and +1.1V.
